(19) United States
(12) Patent Application Publication
(10) Pub. No.: US 2024/0301908 A1
(43) Pub. Date: Sep. 12, 2024

(54) WATER STOP MOUNTING STRUCTURE OF BOLT TO PLATE-LIKE METAL MEMBER

(71) Applicant: Aoyama Seisakusho Co., Ltd., Niwa-Gun (JP)

(72) Inventors: Yuichiro SUZUKI, Niwa-Gun (JP); Keiichiro MASUI, Niwa-Gun (JP); Mitsuki YOSHIDA, Niwa-Gun (JP); Koji MURAKAMI, Niwa-Gun (JP)

(73) Assignee: Aoyama Seisakusho Co., Ltd., Niwa-Gun (JP)

(21) Appl. No.: 18/669,749

(22) Filed: May 21, 2024

Related U.S. Application Data
(63) Continuation of application No. PCT/JP2023/007454, filed on Mar. 1, 2023.

(30) Foreign Application Priority Data
Mar. 2, 2022 (JP) 2022-031456

(51) Int. Cl. F16B 33/00

(52) U.S. Cl. CPC F16B 33/004

(57) ABSTRACT

A water stop mounting structure of a bolt to a plate-like metal member where a caulking bolt is used in which a screwless portion between an upper end of a male screw of the caulking bolt and a bearing surface of a head portion of the bolt thicker than an effective diameter of the male screw. Inserting this caulking bolt into the pilot hole of the plate-like metal member and caulking, metal of a circumferential edge portion of the pilot hole is plastically deformed toward the screwless portion to be brought in close contact with the screwless portion, and water is stopped. Applying sealant to a bearing surface of the caulking bolt produces a structure in which the sealant flows between the circumferential edge portion of the pilot hole of the plate-like metal member and the bolt at the time of being press-fitted and water is stopped.

### TECHNICAL FIELD

The present invention relates to a water stop mounting structure of a bolt to a plate-like metal member.

### BACKGROUND ART

In order to attach a roof rail to a roof panel forming a ceiling portion of an automobile, a plate-like metal member called a roof rail bracket is used. As disclosed in Patent Literature 1, a bolt is attached to a roof rail bracket, and the roof rail bracket is fixed to a roof panel by using the bolt.

Since the bolt penetrates the roof panel, if there is a gap between a pilot hole of the roof rail bracket and the bolt, there is a possibility that rainwater falling on the roof rail bracket goes along a shaft portion of the bolt and enters the vehicle interior. Therefore, conventionally, a bolt having a seal washer is used as this bolt. A bolt having a seal washer is inserted from a ceiling side, a nut is screwed from an interior side to bring the seal washer into close contact with the roof rail bracket, and thus rainwater is prevented from entering.

However, when an operation of engaging the bolt having a seal washer with the nut in the interior to tighten to each other is performed, there is a problem that the bolt having a seal washer idles due to a torque applied to the nut, and thus workability is bad. Furthermore, since the bolt having a seal washer is formed by two members of the bolt body and the seal washer, there is a problem that the cost for the bolt increases. The above-described problem is not limited to the roof panel bracket, and may also occur in a case where a bolt is attached to a plate-like metal member such as a roof panel, a dash panel, a floor panel, a battery pack, or a door panel, which is required to have water-stop performance.

### CITATION LIST

### Patent Literature

[PTL 1]
JP 2005-297841 A

### SUMMARY OF INVENTION

### Technical Problems

An object of the present invention is to solve the above-described problems in the conventional art and to provide a water stop mounting structure of a bolt to a plate-like metal member, which is excellent in water-stop performance and workability, and is low-cost.

### Solutions to Problems

The invention of claim 1 made to solve the above-described problem is a water stop mounting structure of a bolt to a plate-like metal member, in which the bolt is a caulking bolt inserted into a pilot hole of the plate-like metal member and caulked, the caulking bolt has a screwless portion between an upper end of a male screw formed on a bolt shaft portion and a bearing surface of a head portion of the bolt, the screwless portion being thicker than an effective diameter of the male screw, and metal of a circumferential edge portion of the pilot hole of the plate-like metal member is plastically deformed toward the screwless portion at a time of being caulked to be brought into close contact with the screwless portion, and water is stopped.

Furthermore, the invention of claim 2 made to solve the above-described problem is a water stop mounting structure of a bolt to a plate-like metal member, in which the bolt is a caulking bolt inserted into a pilot hole of the plate-like metal member and caulked, and a sealant flows between a circumferential edge portion of the pilot hole of the plate-like metal member and the bolt at the time of being caulked when the sealant is applied to a bearing surface of the bolt, and water is stopped.

### Advantageous Effects of Invention

In the water stop mounting structure of a bolt to a plate-like metal member of the present invention, since the caulking bolt inserted and caulked into a pilot hole of the plate-like metal member is used as a bolt for fixing the plate-like metal member, the caulking bolt does not rotate with respect to the plate-like metal member. Therefore, the caulking bolt does not idle when the nut is tightened, and the workability of tightening the nut can be improved.

Furthermore, in the water stop mounting structure of a bolt to a plate-like metal member of the present invention, it is possible to form a water stop structure by using a single caulking bolt without requiring the bolt with a seal washer formed by two members of the conventional art, and thus, it is possible to reduce the cost for the bolt.

### BRIEF DESCRIPTION OF DRAWINGS

FIG. 1 is a cross-sectional view illustrating an overall structure in a state in which a roof rail bracket which is a plate-like metal member is fixed to a roof panel.

FIG. 2 is an enlarged front view of a caulking bolt used in a first embodiment.

FIG. 3 is a cross-sectional view illustrating a state in which the caulking bolt of the first embodiment is inserted into a pilot hole of a roof rail bracket which is a plate-like metal member.

FIG. 4 is a cross-sectional view illustrating a state in which the caulking bolt of the first embodiment is inserted into a pilot hole of a roof rail bracket which is a plate-like metal member and caulked.

FIG. 5 is an enlarged front view of a caulking bolt used in a second embodiment.

FIG. 6 is a cross-sectional view illustrating a state in which the caulking bolt of the second embodiment is inserted into a pilot hole of a roof rail bracket which is a plate-like metal member and calked.

### DESCRIPTION OF EMBODIMENTS

### First Embodiment

Hereinafter, a first embodiment of the present invention will be described. In first and second embodiments to be described below, a water stop mounting structure of a bolt to a roof rail bracket which is a plate-like metal member will be described. The roof rail bracket is fixed to a roof panel by using the bolt.

However, the plate-like metal member in the present invention is not limited to the roof rail bracket, and can be widely applied to a roof panel, a dash panel, a floor panel, a battery pack, a door panel, and the like, which is required to have water-stop performance.

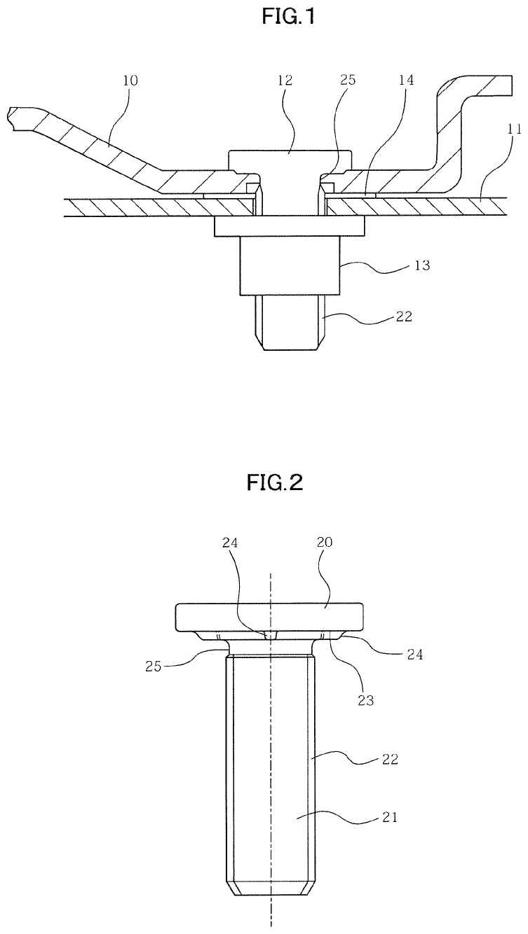

FIG. 1 illustrates an overall structure in a state in which the roof rail bracket is fixed to the roof panel. In FIG. 1, reference numeral 10 denotes the roof rail bracket which is a plate-like metal member, and reference numeral 11 denotes a roof panel of an automobile. Reference numeral 12 denotes a caulking bolt which is a bolt attached to a roof rail bracket 10, and 13 denotes a nut screwed to the caulking bolt 12 from an interior side. Reference numeral 14 is a sponge which is disposed between the roof rail bracket 10 and the roof panel 11. As will be described below, after being inserted into a pilot hole of the roof rail bracket 10 and caulked to stop water, the caulking bolt 12 is inserted into the roof panel 11, and fixed by the nut 13.

FIG. 2 is an enlarged front view of the caulking bolt 12 used in the first embodiment. In FIG. 2, reference numeral 20 denotes a head portion of the bolt, reference numeral 21 denotes a shaft portion of the bolt, and reference numeral 22 denotes a male screw formed on the shaft portion 21. Reference numeral 23 denotes a bearing surface of the head portion 20, and a star-like protrusion 24 is formed on the bearing surface 23 over the entire circumference. The protrusion 24 has a function of biting into the roof rail bracket 10 and preventing the bolt from idling when the caulking bolt 12 is inserted into the roof rail bracket 10 which is a plate-like metal member and caulked.

A screwless portion 25 is formed between the upper end of the male screw 22 of the caulking bolt 12 and the bearing surface 23. The diameter of the screwless portion 25 is formed to be greater than that of a normal caulking bolt. Specifically, the diameter of the screwless portion 25 is greater than the effective diameter of the male screw 22 and smaller than the outer diameter of the male screw 22. For example, in the case of M8 size, according to JIS, because the outer diameter of the male screw is specified to be 8.000 mm, the root diameter to be 6.647 mm, and the effective diameter to be 7.188 mm, the diameter of the screwless portion 25 is set to be greater than 7.188 mm and smaller than 8.000 mm.

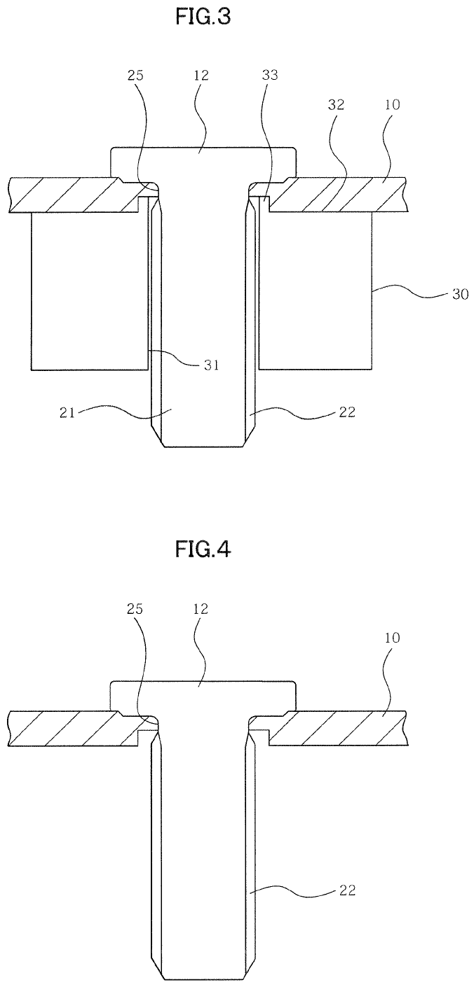

FIG. 3 is a cross-sectional view illustrating a state in which the caulking bolt 12 is inserted into the pilot hole of the roof rail bracket 10 which is a plate-like metal member. Reference numeral 30 is a die and includes a center hole 31 through which the shaft portion 21 of the caulking bolt 12 is inserted. An upper surface 32 of the die 30 is a flat surface on which the roof rail bracket 10 is placed, and a narrow annular protrusion 33 is formed at the center portion of the upper surface 32 of the die 30. Pressure is applied from above to the caulking bolt 12 by a punch (not illustrated), and the caulking bolt 12 is inserted into the pilot hole of the roof rail bracket 10 and caulked.

By this pressure, the protrusion 24 formed on the bearing surface 23 of the caulking bolt 12 bites into the upper surface of the roof rail bracket 10, and thus the caulking bolt 12 is firmly fixed. At the same time, the annular protrusion 33 of the die 30 bites into a circumferential edge portion of the pilot hole of the roof rail bracket 10, and the metal of the portion is plastically deformed toward the screwless portion 25 of the caulking bolt 12 to be brought into close contact with the screwless portion 25. As described above, since the screwless portion 25 has a greater diameter than usual, the metal of the circumferential edge portion of the pilot hole can easily be brought into close contact with the screwless portion 25 without a gap as illustrated in FIG. 4. Data of the water stop performance and data of the idling torque are shown in the example to be described later.

As described above, when the caulking bolt 12 having the screwless portion 25 thickened is caulked and fixed to the roof rail bracket 10 which is a plate-like metal member by using the die 30 including the annular protrusion 33, even in a case where rainwater enters from a gap between the bearing surface 23 of the caulking bolt 12 and the upper surface of the roof rail bracket 10, the portion of the screwless portion 25 prevents the rainwater from further entering, and an excellent water stop effect can be obtained. Furthermore, since the caulking bolt 12 is firmly fixed to the roof rail bracket 10, the tightening workability can be improved without the caulking bolt 12 idling when the nut 13 illustrated in FIG. 1 is tightened. Moreover, unlike the bolt with a seal washer of the related art, only the caulking bolt 12 needs to be used, and thus the cost for the bolt can be reduced.

### Second Embodiment

Next, a second embodiment of the present invention will be described. The second embodiment is the same as the first embodiment in that the caulking bolt 12 is inserted into a roof rail bracket 10 which is a plate-like metal member and caulked. However, as illustrated in FIG. 5, a sealant 40 is applied to the bearing surface 23 of the caulking bolt 12 to which pressure is applied at the time of caulking. As the sealant 40, an epoxy resin thermoplastic sealant that is frequently used in the technical field of bolt nuts can be used, but the material of the sealant is not necessarily limited thereto.

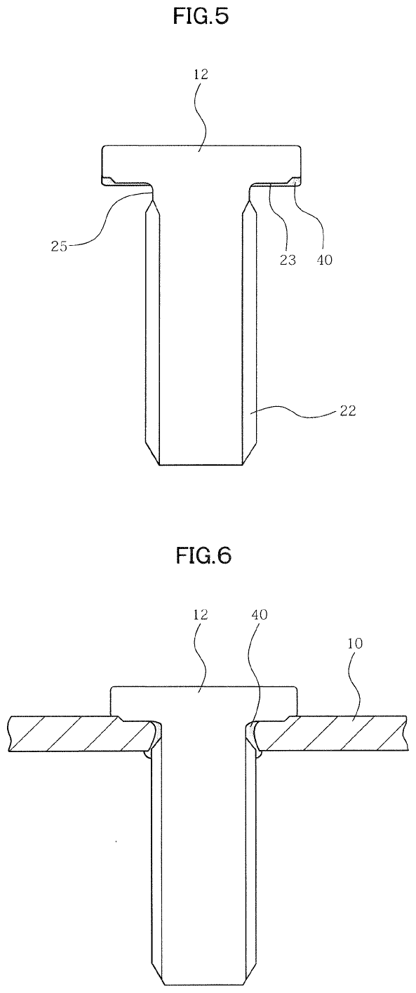

When the caulking bolt 12 in which the sealant 40 is applied to the bearing surface is inserted into the pilot hole of the roof rail bracket 10 which is a plate-like metal member and caulked in this manner, the sealant 40 extruded from the bearing surface 23 flows to the screwless portion 25 of the caulking bolt 12 as illustrated in FIG. 6, and seals a portion between the shaft portion 21 of the bolt and the pilot hole of the roof rail bracket 10. Although not illustrated, a part of the sealant 40 also flows to the outer circumferential side of the bearing surface 23 at the time of caulking, thereby enhancing the sealing performance between the bearing surface 23 and the plate-like metal member. Therefore, a water stop effect can be obtained in a similar manner to the first embodiment. Furthermore, an idling prevention effect and a cost reduction effect can be obtained in a similar manner to the first embodiment.

In the second embodiment, it is not always necessary to make the diameter of the screwless portion 25 of the caulking bolt 12 thicker than usual or to use the die 30 provided with the annular protrusion 33. However, when the first embodiment and the second embodiment are combined, the caulking bolt 12 having the screwless portion 25 with a large diameter is used, the sealant 40 is applied to the bearing surface 23, and caulking is performed using the die 30 having the annular protrusion 33, a more excellent water stop effect can be obtained.

### Example

The results of an evaluation experiment of a product of the present invention are shown below.

A pilot hole having a diameter of 8.0 mm was formed in a test piece having a plate thickness of 0.5 mm and made of a steel plate made of the same material as that of the roof rail bracket, and a caulking bolt having the shape illustrated in FIG. 1 was caulked using a die and a punch. A caulking load is 100 kN. Apart from this, a sample in which an epoxy resin sealant was applied to a bearing surface of a caulking bolt was also prepared.

Next, the nut was fixed to the caulking bolt, the nut was rotated by a torque wrench, and the torque (idling torque) when the caulking bolt was separated from the test piece and idled was measured. As a result, an average value (N=5) of the idling torque was 23.8 N m in a case where the sealant was not used, and an average value (N=5) of the idling torque was 26.4 N m in a case where the sealant is used, both of which showed good results.

Next, a test piece (N=6) was placed at a position of a water depth of 30 mm, and a water leakage test was performed. As a result, a water leakage amount after the lapse of 24 hours was zero in a case where the sealant was not used and in a case where the sealant was used. Moreover, a test of bubbling air in water was also performed, but the water leakage amount was zero, and it was confirmed that there was complete sealing property.

As described above, the water stop mounting structure of a bolt to a plate-like metal member of the present invention has advantages of excellent water stop performance, excellent workability, and low cost, and is excellent in practicality.

### REFERENCE SIGNS LIST

Roof rail bracket which is plate-like metal member
11 Roof panel
12 Caulking bolt
13 Nut
14 Sponge
20 Head portion of bolt
21 Shaft portion of bolt
22 Male screw
23 Bearing surface
24 Protrusion
25 Screwless portion
30 Die
31 Center hole
32 Upper surface
33 Annular protrusion
40 Sealant

The invention claimed is:

1. A water stop mounting structure of a bolt to a plate-like metal member, wherein
the bolt is a caulking bolt inserted into a pilot hole of the plate-like metal member and caulked,
the caulking bolt has a screwless portion between an upper end of a male screw formed on a bolt shaft portion and a bearing surface of a head portion of the bolt, the screwless portion being thicker than an effective diameter of the male screw, and
metal of a circumferential edge portion of the pilot hole of the plate-like metal member is plastically deformed toward the screwless portion at a time of being caulked to be brought into close contact with the screwless portion, and water is stopped.

2. A water stop mounting structure of a bolt to a plate-like metal member, wherein
the bolt is a caulking bolt inserted into a pilot hole of the plate-like metal member and caulked, and
a sealant flows between a circumferential edge portion of the pilot hole of the plate-like metal member and the bolt at the time of being caulked when the sealant is applied to a bearing surface of the bolt, and water is stopped.
